(19) United States
(12) Patent Application Publication
(10) Pub. No.: US 2026/0065704 A1
(43) Pub. Date: Mar. 5, 2026

(54) PRETRAINED MODEL FOR EXTRACTING CONTENT FROM A PLURALITY OF DOMAINS

(71) Applicant: Antworks Pte Ltd

(72) Inventors: Laurence Anthony Trigwell, Haywards Heath (GB); Benjamin Ryan Platts, Lechhlade (GB); Josmin Jose, Kerala (IN)

(73) Assignee: Antworks Pte Ltd, (omitted)

(21) Appl. No.: 18/883,410

(22) Filed: Sep. 12, 2024

(30) Foreign Application Priority Data
Sep. 5, 2024 (IN) 202421067076

(51) Int. Cl. G06V 30/414; G06V 30/19

(52) U.S. Cl. CPC G06V 30/414; G06V 30/19013; G06V 30/19127

(57) ABSTRACT

The invention provides a method for processing domain-specific documents by tagging unique fields with expected values and defining their characteristics. Based on these characteristics, appropriate tool categories and combinations of tools are selected using a tool selection framework to extract values from each field. Each extracted value is assigned a confidence score by matching it with the expected value. The tool categories and combinations are updated dynamically based on the confidence scores to improve accuracy. Additionally, the method derives tool categories and combinations for new fields by analyzing commonalities with existing fields, and applies these to documents from different domains by considering domain-specific definitions. This adaptive approach enhances the precision and versatility of data extraction across various document types and industries.

### PRIORITY STATEMENT

The present application claims priority under 35 U.S.C. § 119 to Indian patent application number 202421067076 filed Sep. 5, 2024, the entire contents of which are hereby incorporated herein by reference.

### FIELD

The present invention relates to content retrieval from data representational structures such as documents, emails forms, and the like and more particularly to a pretrained model for extracting content from a plurality of domains.

### BACKGROUND

Current systems for identifying and extracting relevant content from heterogenous data sources such as medical bills, commercial insurance documents, life insurance policies, application forms, and the like, face significant challenges. Unstructured data, in particular, presents several challenges, including usability, volume variations, variability in representation and quality of documents. The variability in representational formats, such as unstructured free-flowing text with presentment of the same information in a table, bullets, embedded in a paragraph, and via diagrams, figures, charts, and other formats, makes it difficult to consume this data systemically for decision making purposes. The volume of unstructured data is also growing at an exponential rate, further complicating the collection and extraction of relevant information. Moreover, these documents often come in various styles, formats, and codes with similar intents, further adding complexity to the extraction process. The quality of these documents is also often compromised due to their origin from different sources and variation in technologies used to convert a document into image and then to text.

For instance, insurance policies typically contain crucial information such as sums insured, limits of indemnity, vehicle schedules, policy extensions, inner limits and estimates like turnover and fee income. This information is often provided in various report formats by multiple underwriters, each presenting their quotations in different formats. As a result, comparison of quotations between plurality of insurance policies to extract content that meets client requirements is complex, time-consuming and prone to administrative errors. Various approaches have been employed to extract content from such heterogenous data structures as explained hereinbelow.

Traditionally, rule-based matching approaches have been employed to extract relevant data from such documents. The rule-based approaches involve writing specific rules to identify patterns in the text, which are then extracted. However, rule-based systems have limitations. When documents are updated, or new layouts or structures are adopted, the rule-based approaches fail to extract necessary information, thereby leading to inefficiencies and need for manual intervention. In order to address such shortcomings, machine learning models have been developed, where annotated examples of data are extracted and used to train the model. However, machine learning models have several limitations, including challenges in gathering sufficient training context, and training data, to ensure accurate extraction.

For example, data extraction tools based on Natural Language Processing (NLP) and machine learning have been developed for extracting, interpreting, classifying, and analyzing unstructured data within policies, quotes, binders, and endorsements. These tools, once fully trained on over five hundred or more named entities, are able to categorize entities automatically. However, the process of labelling the data requires supervised training which is time consuming. In some cases, it may take anywhere from four to twelve months of training the model for a new set of client documents. Some tools which operate based on positional alignment, pose the risk of incorrect data extraction, when data presented in a new document is in a slightly different position on the page.

To overcome these challenges, a novel pretrained model for automatically extracting and classifying data from heterogenous documents from multiple domains is proposed. The pretrained model should provide high accuracy and require minimal ongoing maintenance.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a method for developing a pretrained model for extracting content from a plurality of domains, is disclosed. The method includes receiving the plurality of documents, wherein each document is associated with a specific domain. The method further includes tagging each unique field of a document with an expected value, also known as a ground truth or correct value for the each unique field. Further, the method includes defining a plurality of field characteristics for the each unique field of the document and selecting for the each unique field one or more tool categories from a tool selection framework, and a combination of tools for each tool category based on the plurality of field characteristics.

The method further includes, extracting one or more values associated with the each unique field in the each document, by using the one or more tool categories, and the combination of tools in the each tool category, where each value is associated with a confidence score obtained by matching the one or more extracted values associated with the each unique field with the expected value of the each unique field. Examples of the one or more tool categories comprise one or more of a regionalization, layout detection, pattern detection, content extraction, data validation and data transformation set of tools. For example, the data validation tool category comprises a plurality of business rules applicable to a domain associated with the a document. Further, the plurality of field characteristics for the each unique field comprises a length, a location, a data type, a pattern, a layout, one or more business rules, and a content vicinity information of the each unique field.

Based on the confidence score, the one or more tool categories and the combination of tools for the each unique field are updated. In an embodiment, updating the one or more tool categories and the combination of tools for the each unique field, further comprises updating a predefined order of applying the combination of tools, for the each unique field element. Further, a new field that appears in the plurality of documents, the method includes deriving a set of tool categories, a combination of tools, and a predefined order of applying the combination of tools for the new field, based on a set of tool categories and a combination of tools for each tool category already selected for existing fields, and commonalities of field characteristics between the new field and the existing fields. The existing fields refer to one or more unique fields for which the set of tool categories and the combination of tools for the each tool category, is selected as mentioned above.

Further, for a new field belonging to a different domain, the method includes, deriving one or more tool categories and a combination of tools for each tool category for the new field based on tool categories and the combination of tools for the each tool category associated with the one or more existing fields, and commonalities of field characteristics between the new field and the one or more existing fields, and one or more domain definitions associated with the different domain. Hence, by this approach tools required for identifying a new field are derived autonomously.

In an embodiment, the one or more tool categories, the combination of the one or more tools for the each unique field, is selected based on a confidence score obtained by matching the expected value of the each unique field with the one or more extracted values of the each unique field obtained from the plurality of documents of the specific domain.

Typically, the combination of the one or more tools includes a predefined order in which the one or more tools are applied. The selection of the combination of the one or more tools and the predefined order for the each unique field, are modified to get the confidence score above a predetermined threshold, as having the confidence score above the predetermined threshold is indicative of an accurate extraction. Hence, such combination of one of more tools and the predefined order is chosen for the each unique field that ensures the extracted value associated with the each unique field is closest to the expected value or the ground truth value.

According to an example embodiment, a system for developing a pretrained model for extracting content from a plurality of documents or corpus of document, is disclosed. In an example, the corpus of documents can be a set of insurance policy documents, and the content can be related to limits of liability provided within each document. Typically, the plurality of documents or corpus of documents is associated with a specific domain, such as medical records, or insurance policies. The system includes at least one processor; a memory storing instructions that, when executed by the at least one processor, cause the system to receive the corpus of documents associated with a specific domain, tag each unique field of a document with an expected value; define a plurality of field characteristics for the each unique field of the document, and select for the each unique field one or more tool categories, and a combination of tools for each tool category, based on the plurality of field characteristics, wherein the one or more tool categories and the combination of tools for the each tool category are defined in a tool selection framework. The system is further configured to extract one or more values associated with the each unique field in the each document by using the one or more tool categories, and the combination of tools in the each tool category, where each value is associated with a confidence score obtained by matching the one or more extracted values associated with the each unique field with the expected value of the each unique field; and update the one or more tool categories and the combination of tools for the each unique field based on the confidence score.

According to another example embodiment, a non-transitory computer-readable medium having stored thereon computer-readable instructions that when executed by the processor cause the processor to develop a pretrained model that is configured to receive the plurality of documents associated with one or more domains, tag each unique field of a document with an expected value, define a plurality of field characteristics for the each unique field of the document, and select for the each unique field one or more tool categories, and a combination of tools for each tool category, based on the plurality of field characteristics, wherein the one or more tool categories and the combination of tools for the each tool category are defined in a tool selection framework. The system is further configured to extract one or more values associated with the each unique field in the each document by using the one or more tool categories, and the combination of tools in the each tool category, wherein each value is associated with a confidence score obtained by matching the one or more extracted values associated with the each unique field with the expected value of the each unique field; and update the one or more tool categories and the combination of tools for the each unique field based on the confidence score.

The pretrained model is further configured to derive a set of tool categories, a combination of tools and a predefined order of applying the combination of tools for a new field in a document of the specific domain based on tool categories and a combination of tools selected for existing fields and commonalities of field characteristics between the new field and the existing fields. The pretrained model is then configured to utilize the set of tool categories and the predefined order of applying the combination of tools to extract value associated with the new field in the document of the specific domain.

The pretrained model is further configured to derive one or more tool categories, a combination of tools for each tool category and a predefined order of applying the combination of tools for a new field identified in a document pertaining to a different domain, based on tool categories, combination of tools for the each tool category and an order to applying the combination of tools associated with one or more existing fields of the specific domain, commonalities of field characteristics between the new field and the one or more existing fields and one or more domain definitions associated with the different domain. The pretrained model is further configured to utilize the set of tool categories and the predefined order of applying the combination of tools to extract value associated with the new field in the document of the different domain.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 illustrates a flowchart depicting a method of developing a pretrained model for extracting content from a plurality of domains, according to an example embodiment;

FIG. 2 is a block diagram of a system configured to develop a pretrained model for extracting content from a corpus of documents, according to an embodiment;

FIG. 3 illustrates an example document on which the pretrained model of FIG. 2 is developed, according to an example embodiment; and

FIG. 4 is a block diagram of an embodiment of a computing device in which the modules of the system of FIG. 2, described herein, are implemented.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Similarly, like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any, and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skills in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in ‘addition to the orientation depicted in the figures. For example, if the device in the figures is turned over, elements described as “below”, or “beneath” other elements or features would then be oriented “above” the other elements or features. Thus, term such as “below” may encompass both an orientation of above and below. The device may be otherwise oriented (rotated 90 degrees or at other orientations) and the spatially relative descriptors used herein are interpreted accordingly.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

At least one example embodiment is generally directed to techniques for developing a pretrained model for extracting content from a plurality of domains. In particular, the embodiments disclose techniques relating to training machine learning models on a plurality of documents for identifying a plurality of content. The embodiments disclosed provide a system and method for developing a pretrained model to accurately extract content from domain-specific documents. It involves tagging each unique field in the documents with an expected value, defining field characteristics, and selecting the most suitable tools from a tool selection framework for extracting values. The extracted values are matched with the expected values and assigned confidence scores, which are used to update and optimize the tool selection process continuously. This approach ensures high accuracy, adaptability, and continuous improvement in extracting data from various documents. Detailed working is explained hereinbelow with reference to the figures.

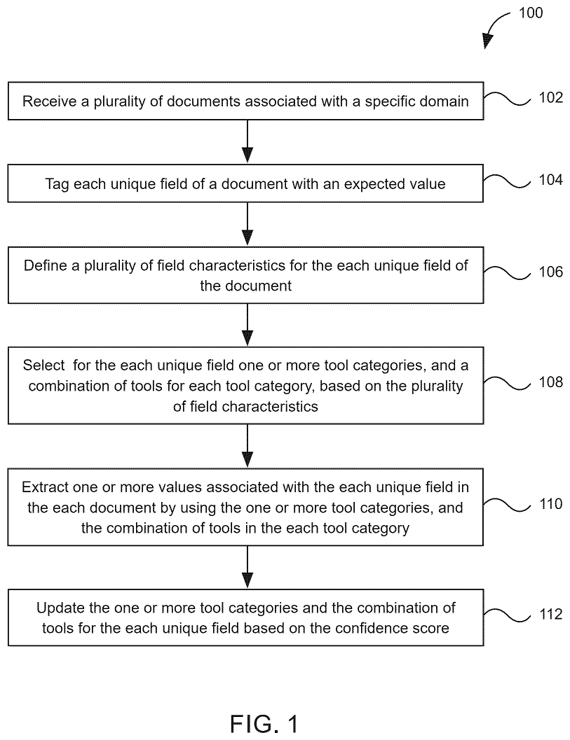

FIG. 1 illustrates a flowchart (100) depicting a method of developing a pretrained model for extracting content from a plurality of documents, according to an example embodiment. The pretrained model is a machine learning model, that is trained to identify and extract content from documents spanning multiple domains. The pretrained model is called pretrained due to its capability of accurately extracting content from documents on which it has not been trained on earlier.

At 102, a plurality of documents is received, where the plurality of documents is associated with a specific domain. For example, a sample of 100 insurance policy documents may be received for developing the pretrained model. The insurance documents may include various layouts, text, tables, graphics, images and other types of content. Each document can include a plurality of fields and associated data.

At 104, each unique field of a document is tagged with an expected value. The expected value is a ground truth or verified data that is used to train the pretrained model.

At 106, a plurality of field characteristics for the each unique field of the document is defined. Examples of field characteristics include a length, a location, a data type, a pattern, a layout, one or more business rules, and a content vicinity information of the each unique field. For example, the length of a field indicates a minimum and maximum number of characters for the field. The location can include a specific page or range of pages in which the field normally appears. The location can also include details of zones in which the field appears, where zones are vertical or horizontal areas into which a page is divided virtually. The data type of the field can include a type of data value that is usually associated with the field, such as alphabet, numeric, alpha-numeric, date and the like. The data type can also be a regular expression (regex) if the field is usually referred by the regex, in the specific domain. The layout refers to a representation of the field in the document. For example, the field can have a simple layout if content of the field is available in a single line and an anchor text is present to identify a location of data and follows the same structure across documents.

At 108, for the each unique field one or more tool categories are selected, and a combination of tool for each tool category is selected based on the plurality of field characteristics, where the one or more tool categories and the combination of tools for the each tool category are defined in a tool selection framework. In an embodiment, the one or more tool categories includes one or more of a regionalization, layout detection, pattern detection, content extraction, data validation, and data transformation set of tools.

In an embodiment, the one or more tool categories and the combination of the one or more tools, for the each unique field is selected based on a confidence score obtained by matching the expected value of the each unique field with the one or more extracted values of the each unique field obtained from the plurality of documents of the specific domain. Furthermore, the combination of the one or more tools includes a predefined order in which the one or more tools are applied. The selection of the combination of the one or more tools and the predefined order for the each unique field, are modified to get the confidence score above a predetermined threshold, as having the confidence score above the predetermined threshold is indicative of an accurate extraction.

Further, for a new field found in a document belonging to the same specific domain, a set of tool categories, a combination of tools, and a predefined order of applying the combination of tools is derived based on tool categories and a combination of tools selected for existing fields in the plurality of documents and is also based on commonalities of field characteristics between the new field and the existing fields.

At 110, one or more values associated with the each unique field in the each document are extracted by using the one or more tool categories and the combination of tools in the each tool category. In an embodiment, the combination of tools includes a predefined order in which the combination of tools needs to be applied on the each unique field. Further, each value is associated with a confidence score obtained by matching the one or more extracted values associated with the each unique field with the expected value of the each unique field.

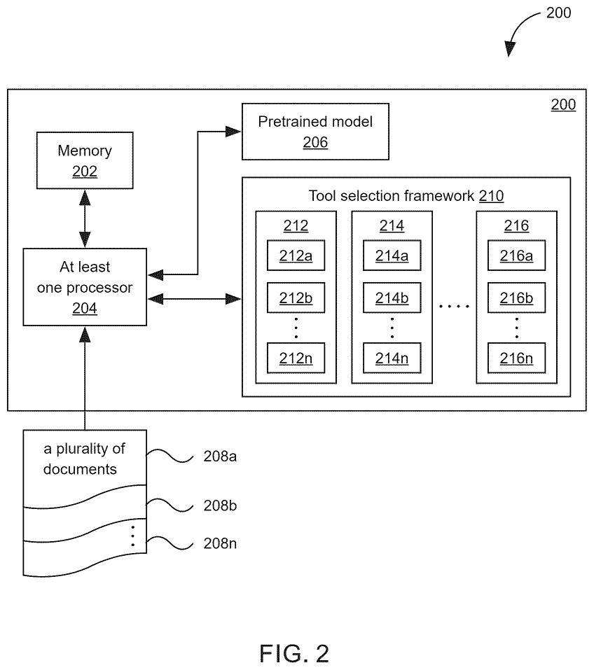

At 112, the one or more tool categories are updated and the combination of tools for the each unique field is updated based on the confidence score. In an embodiment, updating the one or more tool categories comprises updating a predefined order of applying the combination of tools for the each unique field element. Typically, a computing system such as system 200 shown in FIG. 2 is used for creating the pretrained model, as discussed hereinbelow.

FIG. 2 is a block diagram of the system 200 configured to develop a pretrained model 206 for extracting content from a corpus of documents, according to an embodiment. The corpus of document is also referred to as a plurality of documents 208a-208n belonging to a specific domain. Typically, the system 200 is trained on the plurality of documents 208a-208n from the specific domain first and is then trained by way of extrapolation and self-learning on documents belonging to different domains, as explained further. The system 200 includes a memory 202 storing instructions, and at least one processor 204 that executed the instructions, to cause the system 200 to develop the pretrained model 206. The pretrained model 206 can be coupled internally, as shown in FIG. 2, or externally (not shown in FIG. 2) with the system 200.

The at least one processor 204 receives the plurality of documents 208a-208n and tags each unique field of a document (e.g. 108a) with an expected value of ground truth (GT). The at least one processor 204 further defines a plurality of field characteristics for the each unique field of the document (e.g. 108a). Further, the at least one processor 204 selects for the each unique field one or more tool categories 212-214 and a combination of tools 212a-212b for each tool category 212a from a tool selection framework 210. The one or more tool categories 212-216 are selected based on the plurality of field characteristics of the each unique field element. In an embodiment, the tool selection framework 210 comprises a plurality of tool categories 212-216 and each tool category 212 comprises a plurality of tools 212a-212n. For example, tool category 214 comprises a plurality of tools 214a-214n, and tool category 216 comprises a plurality of tools 216a-216n.

By using the one or more tool categories (e.g. 212) and the combination of tools in the each tool category for the each unique field, one or more values associated with the each unique field is extracted. Typically, each of the extracted values is matched with the ground truth of the each unique field, to get a respective confidence score. The one or more tool categories and the combination of tools for the each category corresponding to the extracted value that has a confidence score above a predetermined threshold and that is highest among other extracted values is updated for the each unique field. In an embodiment, the system 200 updated the one or more tool categories, the combination of tools for the each tool category and a predefined order of applying the combination of tools, for the each unique field element. Further, for a new field, the system 200 derives a set of tool categories, a combination of tools for the new field based on tool categories, and a combination of tools selected for existing fields and commonalities of field characteristics, between the new field and the existing fields, where the new field and the existing fields belong to one or more documents of the corpus of documents of the specific domain. Typically, the system 200 selects one or more tool categories, and the combination of the one or more tools for the each unique field based on the confidence score. The confidence score is basically obtained by matching the expected value of the each unique field with the one or more extracted values of the each unique field, obtained from the plurality of documents of the specific domain.

Further, the system 200, derives one or more tool categories and combination of tools for each tool category for a new field identified in a document pertaining to a different domain, based on tool categories and combination of tools for the each tool category associated with one or more existing fields of the specific domain. Commonalities of field characteristics between the new field and the one or more existing fields and one or more domain definitions associated with the different domain are considered by the system while deriving the one or more tool categories and the combination of the tools. In an embodiment, the tool category is one of a regionalization, layout detection, pattern detection, content extraction, data validation, and data transformation set of tools. Operation of the system 200 in creating the pretrained model, is further explained below with reference to an example.

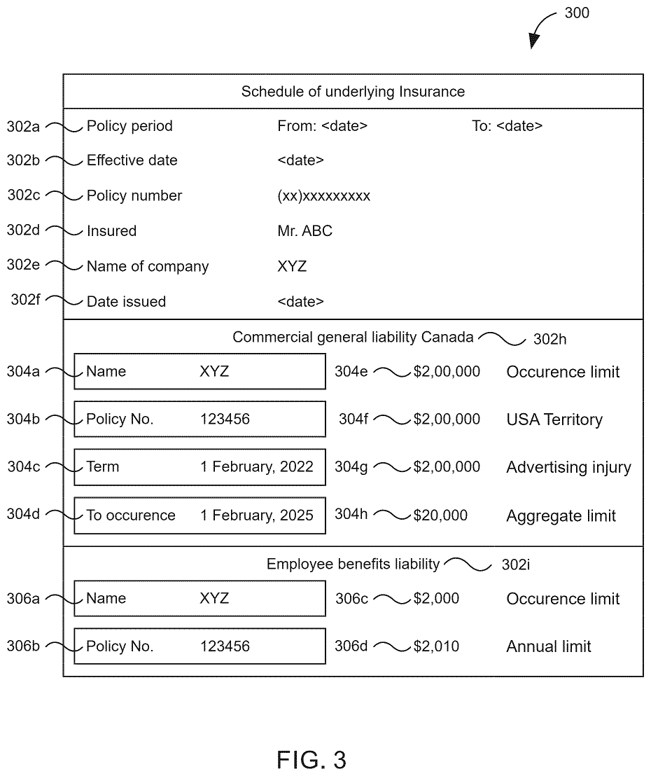

FIG. 3 illustrates an example document 300 on which the pretrained model of FIG. 2 is developed, according to an example embodiment. As shown the document 300 contains a plurality of fields 302a-302h. Say content for field 302a is to be extracted, then one or more tool categories, and combination of tools for each tool category for the field 302a is first determined based on field characteristics of the field 302a. The field characteristics for field 302a can be identified as follows. For example, as content for the field 302a is available in a single line, as shown below, field 302a is tagged as a simple field:

| | |
|---|---|
| Policy Number | (23) 78193230 |

Further, a field length and data type characteristic are defined for the field 302a. For example, the field length and data type of the field 302a can be defined as 10 alphanumeric characters. Example of, a compound field is field 302h (Commercial General Liability Canada). Typically, compound fields span multiple lines and have multiple sub-fields. For example, as shown below, field 302h includes a plurality of sub-fields (304a-304h) that span four different lines. For example, 302h includes sub-field 304a (Name), sub-field 304b (Policy No.), and sub-field 304c (Term), sub-field 304d (to Occurrence). A composite field can be represented in the form of tables, paragraphs or lists. For example, the composite sub-field 302h is represented in the form of a paragraph as shown below:

Commercial General Liability Canada

| | | |
|---|---|---|
| Name: | XYZ | $2,000,000 Each Occurrence Limit |
| Policy No.: | 3985678 | $2,000,000 USA Territory |
| | | Aggregate Limit |
| Term: | Feb. 1, 2022, | $ 2,000,000 Advertising |
| | | injury and Personal |
| To Occurrence: | Feb. 1, 2025, | $ 2,000,000 Aggregate Limit other GL |

Further, business rules or domain specific rules can be provided as a field characteristic. For example, for the field 302e “Insured”, a business rule can be defined as follows: the insured name cannot be a broker name, and the insured name should be picked up from the declaration section. Further, optional information can be provided as a field characteristic, like field element vicinity. The field element vicinity characteristic can provide one or more field elements that are available within a predefined distance from another field element. For example, field 302a “Policy Period”, field 302b “Effective date”, field 302c “policy number” and field 302d “Insured” come close to each other and can be included within the field element vicinity characteristic. The defined field characteristics are typically provided as input to the tool selection framework 210, for identifying the tools to be executed for the each unique field.

In an embodiment, the set of tools are grouped into one or more tool categories 212-216, within the tool selection framework 210. Examples of tool categories include regionalization, layout detection, anchor text determination and disambiguation, field content extraction, validation and prioritization. In the regionalization tool category, sections within a document from which relevant data are to be extracted are identified, with specific section headers and footers. For instance, when multiple policy numbers are present, the necessary information is ensured to be extracted from the “Declaration” section, with the start and end points, including page numbers, being specified. In a layout detection tool category, the structure of the content is determined, identifying whether the content is organized as a table, paragraph, or list. The anchor text determination and disambiguation tool category are configured to recognize patterns or labels associated with field elements, thereby enabling accurate categorization. For example, variations in labeling the insured's name, such as “First Name of Insured” or “Insured Name,” are mapped to the correct field element.

In the field content extraction tool category, data are extracted based on single or multiple values, utilizing either extractive or abstractive methods. The extraction may be lookup-based, wherein content is verified against a master list, or extractive, wherein data following specific patterns, such as key-value pairs, are retrieved. Abstractive extraction is facilitated by identifying and mapping contextually relevant information to a label, and may further involve the use of GenAI prompting, where regionalized sections are sent as context to large language models (LLMs). During this process, guard railing is applied to ensure that only necessary context is transmitted, and anonymization is performed to mask or replace unique identifiers with dummy data before submission to the LLMs.

The validation and confidence scoring tool category is utilized to validate field content based on predefined structures, including tables, paragraphs, or specific data types such as dates, addresses, and alphanumeric values, with a confidence score being assigned to the extraction. This tool category includes structure validators that assess the content's structure and business validators that validate field elements against business rules. For instance, if a business rule stipulates that an insurer's name cannot be a broker's name, the results are checked against known broker names, and any matches are excluded. The prioritization tool category includes extracted data from candidates in a ranked manner based on predefined rules or confidence scores.

Typically, once a relevant category is chosen, one or more tools within the tool category are identified based on field characteristics. The tools are initially used in an inherent order, and data is extracted. Based on the extracted value and the confidence score, other tools are prioritized to optimize the performance of the extraction. The combination of tools is basically built and linked by a decision tree. The training data is created in such a way that all tools in the selected tool category are executed. The evaluation metrics such as precision, recall and F-score are evaluated for each combination of tools. The combination of tools with the highest score is then selected. The ordering of the one or more tools, and a priority or predefined order in which the one or more tools are executed, and threshold values at which other tools are involved are determined such that an overall performance is optimized.

The invention presents a highly customizable system for selecting tools to extract data from documents, with the selection process being driven by the specific characteristics of each field within the document. For example, when a field within a document is recognized as requiring extraction based on anchor-text, the system initially opts for a tool specifically designed for anchor-text-based extraction. Suppose this tool achieves a precision of 80%, meaning that 80% of the data it extracts is accurate, and a recall of 70%, meaning it successfully identifies and extracts 70% of all relevant data within the document. While these metrics indicate reasonably good performance, the system doesn't stop here, it also considers other available tools within the same category to determine if an even more effective extraction is possible.

To illustrate, let's consider another tool within the same category that offers a precision of 100%. This means that all the data extracted by this tool is entirely accurate. However, this tool has a lower recall rate of 20%, meaning it only captures 20% of the relevant data, potentially missing a significant portion. Deciding which tool to prioritize in this scenario involves calculating an F(n) score, a weighted harmonic mean of precision and recall. The value of ‘n’ in this formula is a configurable parameter that allows the system to adjust its emphasis on either precision or recall based on the particular needs of the task. For instance, if the focus is on capturing as much relevant data as possible, more weight might be placed on recall; conversely, if accuracy is paramount, precision might be prioritized.

After calculating the F(n) score with the chosen value of ‘n’, if the score favors the first tool, due to its higher recall combined with acceptable precision, the system may prioritize this tool for extraction. However, the system also assigns a confidence score to the extracted data, which indicates how closely the extracted values match the expected or “ground truth” values. If this confidence score does not meet a pre-established threshold, a threshold that can be configured according to the user's needs, the system may then invoke the second tool or even other tools within the same category. This ensures that, even if the second tool has a lower recall, the data it extracts will be of the highest possible precision, thereby maximizing the overall accuracy of the extraction process.

This dynamic and flexible approach allows the system to adapt its tool selection by carefully balancing the trade-offs between precision and recall. This adaptability ensures that the most accurate and comprehensive data extraction possible is achieved for each specific use case. Moreover, the system's configurability through parameters such as ‘n’ in the F(n) score and the confidence threshold provides significant flexibility. It enables users to fine-tune the system to align with the specific requirements of the data extraction task and the criticality of the data being handled.

The prioritization of tools and the assessment of confidence are based on these configurable thresholds, which determine whether an additional tool should be invoked to ensure the desired level of accuracy and completeness. The final output of the extraction process typically includes several key components: the specific region within the document identified for extraction, the layout structure of that region, and the extracted value associated with the target field. These outputs are ordered and presented according to the prioritization logic established by the system.

Furthermore, to continuously improve the tool selection process, the system uses ground truth (GT) data to provide feedback. This feedback is then used to update and refine the tool selection framework, particularly for the specific domain from which the documents are derived. This ongoing feedback loop ensures that the system becomes more effective and efficient over time, adapting to the nuances of the specific domain and improving its data extraction capabilities.

As an example, when the extracted value is part of the candidate set but does not match the ground truth (GT), and such occurrences exceed a threshold percentage, the prioritization tool category is required to be selected. If the extracted value aligns with the GT but requires either format transformation or data correction, such as adding a prefix or suffix, and these occurrences exceed a threshold percentage, the transformation tool category is invoked. After pretraining is completed, this approach is applied to new data for the same field, using the provided field characteristics.

In another example, when a new field is added with unique field characteristics, the algorithm searches for the “nearest neighbor” based on the field characteristics to apply the tool prioritization and decision logic to the new field. For instance, if there are N field elements defined and combinations have been identified, the N+1 field element attempts to map its field characteristics to one of the existing field elements and derive its combinations accordingly. Example of a combination of tools includes, regionalization followed by anchor text determination and disambiguation, followed by field extraction, and followed by a business validator. Example, of a second combination is regionalization, followed by GenAI prompting, followed by an output validator. Example of a third combination is regionalization, layout detections, table extractions, anchor text determination and disambiguation followed by validator.

The system is designed to transfer the knowledge and methodologies developed in one domain to another, making it highly adaptable across various applications. Initially, the system builds a corpus for the first domain, which includes several key components: the documents specific to that domain, the ground truth (GT) data that serves as a benchmark for accuracy, the defined field characteristics that describe the nature of each unique field within the documents, and a detailed mapping of each field to its corresponding field characteristics and the tools selected from the tool usage selection framework.

When the system is applied to a second domain, this corpus from the first domain is leveraged to facilitate the extraction process. The first step involves defining the field characteristics for the new set of fields in the second domain. These characteristics describe the attributes and expected behavior of each field, similar to how they were defined in the first domain. Once the field characteristics for the second domain are established, the system attempts to map each field in this new domain to the appropriate tools within the tool categories. If the field characteristics in the second domain closely match those from the first domain, the system directly applies the same tools and prioritization logic that were used successfully in the first domain. However, if the field characteristics do not perfectly align, the system employs a “nearest neighbor” search algorithm. This algorithm identifies the most similar or closest match among the existing field characteristics from the first domain and applies the corresponding tool prioritization and decision logic to the field in the second domain.

In cases where none of the existing field characteristics from the first domain match those of the fields in the second domain, the system does not default to an arbitrary tool selection. Instead, it reverts to the tool selection framework, following the same methodical steps used in the first domain to derive the most appropriate tools for the new field characteristics. This approach ensures that the system maintains a high level of accuracy and effectiveness, even when adapting to new and unfamiliar domains.

By systematically transferring the teaching from one domain to another, the system not only enhances efficiency by reusing proven methodologies but also ensures that the data extraction process remains robust and adaptable to different types of documents and fields across various domains. This capability of cross-domain transfer and adaptation significantly expands the utility of the system, making it a versatile tool for a wide range of applications.

The disclosed method and system offer a multitude of advantages that significantly enhance the performance and adaptability of machine learning models in processing large, unstructured documents. One of the primary advantages lies in the system's ability to improve model performance by breaking down these large, unstructured documents into smaller, manageable components known as individual field elements. Instead of attempting to train the machine learning model on the entire document as a whole, which can be complex and inefficient, the system segments the document into these distinct field elements. Each field element is then processed and trained individually using the tool selection framework.

This targeted training approach has a substantial positive impact on the relevant performance metrics of the pretrained model. By focusing on individual field elements, the model can achieve higher precision and relevance in its predictions and classifications. For example, the performance metrics that are positively influenced include classification accuracy (the proportion of correctly identified fields), logarithmic loss (which measures the uncertainty of predictions), the confusion matrix (a summary of prediction results on a classification problem), area under the curve (AUC, which measures the ability of the model to distinguish between classes), F1 score (which balances precision and recall), mean absolute error (the average of the absolute differences between predicted and actual values), and mean square error (the average of the squared differences between predicted and actual values). Each of these metrics is crucial in assessing the effectiveness and reliability of the machine learning model, and the disclosed method enhances them by enabling more focused and accurate training on segmented field elements.

Another significant advantage of the disclosed system is its remarkable adaptability to new document types and business domains. The system is designed to learn from existing fields and their characteristics, enabling it to efficiently handle and extract content from documents with similar or different field characteristics without the need to start the training process from scratch for each new document type. This capability is particularly beneficial in business environments where documents can vary widely in format and structure.

By leveraging its ability to learn from similarities in field characteristics across different documents, the system can quickly adapt to new documents, even if they originate from entirely different business domains. This adaptability eliminates the need to invest significant time and resources into repeatedly training the model for each new document type encountered. Instead, the system can abstractly process fields of interest in various formats, ensuring consistent and accurate content generation across a wide range of document types.

This process of abstractive processing involves synthesizing and generating meaningful content from the extracted fields, rather than merely copying or summarizing the data. This ensures that the output is not only accurate but also contextually relevant and useful for the intended application. The ability to maintain high performance across different documents and domains, combined with efficient resource utilization, makes the disclosed method and system a powerful tool for handling diverse document processing tasks in dynamic business environments.

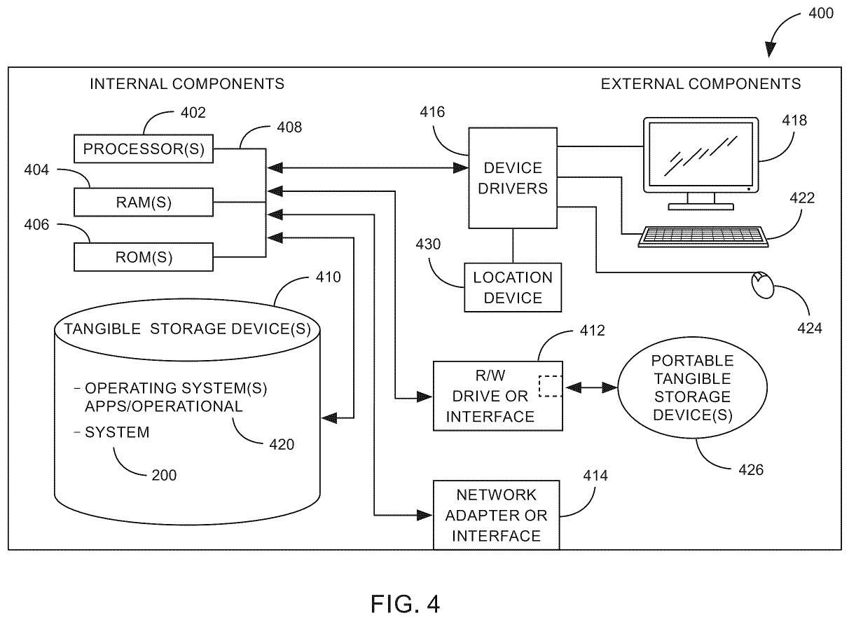

FIG. 4 is a block diagram of an embodiment of a computing device 400 in which the modules of the system 200 of FIG. 2, described herein, are implemented. The modules of the system 200 described herein are implemented in computing devices. The computing device 400 includes one or more processors 402, one or more computer-readable RAMs 404 and one or more computer-readable ROMs 406 on one or more buses 808. Further, computing device 400 includes a tangible storage device 410 that may be used to execute operating systems 420 and the system 200. The various modules of the system 200 may be stored in tangible storage device 410. Both the operating system 420 and the system 100 are executed by processor 402 via one or more respective RAMs 404 (which typically include cache memory). The execution of the operating system 420 and/or the system 200 by the processor 402, configures the processor 402 as a special purpose processor configured to carry out the functionalities of the operation system 420 and/or the system 200 as described above.

Examples of storage devices 410 include semiconductor storage devices such as ROM, EPROM, flash memory or any other computer-readable tangible storage device that may store a computer program and digital information.

Computing devices also include an R/W drive or interface 414 to read from and write to one or more portable computer-readable tangible storage devices 428 such as a CD-ROM, DVD, memory stick or semiconductor storage device. Further, network adapters or interfaces 412 such as a TCP/IP adapter cards, wireless Wi-Fi interface cards, or 3G or 4G wireless interface cards or other wired or wireless communication links are also included in computing device.

In one example embodiment, the system 200 may be stored in tangible storage device 410 and may be downloaded from an external computer via a network (for example, the Internet, a local area network or other, wide area network) and network adapter or interface 412.

Computing device further includes device drivers 416 to interface with input and output devices. The input and output devices may include a computer display monitor 418, a keyboard 424, a keypad, a touch screen, a computer mouse 426, and/or some other suitable input device.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that, one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other examples features of example embodiments may be embodied in the form of an apparatus, method, system, computer program, tangible computer readable medium and tangible computer program product. For example, the aforementioned methods may be embodied in the form of a system or device, including, but not limited to, any of the structures for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device's main body or a removable medium arranged so that it may be separated from the computer device's main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include, but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

We claim:

1. A method of developing a pretrained model for extracting content from a plurality of documents, the method comprising:
receiving the plurality of documents associated with a specific domain;
tagging each unique field of a document with an expected value;
defining a plurality of field characteristics for the each unique field of the document;
selecting for the each unique field one or more tool categories, and a combination of tools for each tool category, based on the plurality of field characteristics, wherein the one or more tool categories and the combination of tools for the each tool category are defined in a tool selection framework;
extracting one or more values associated with the each unique field in the each document by using the one or more tool categories, and the combination of tools in the each tool category, wherein each value is associated with a confidence score obtained by matching the one or more extracted values associated with the each unique field with the expected value of the each unique field; and
updating the one or more tool categories and the combination of tools for the each unique field based on the confidence score, wherein the updated one or more tool categories and the combination of tools of the tool selection framework comprise the pretrained model.

2. The method of claim 1, wherein updating the one or more tool categories and the combination of tools for the each unique field, further comprises:
updating a predefined order of applying the combination of tools, for the each unique field element.

3. The method of claim 2, further comprising:
deriving a set of tool categories, a combination of tools, and a predefined order of applying the combination of tools for a new field based on tool categories and a combination of tools selected for existing fields and commonalities of field characteristics between the new field and the existing fields, wherein the new field and the existing fields belong to one or more documents of the specific domain.

4. The method of claim 2, further comprising:
deriving one or more tool categories and combination of tools for each tool category for a new field identified in a document pertaining to different domain, based on tool categories and combination of tools for the each tool category associated with one or more existing fields of the specific domain, commonalities of field characteristics between the new field and the one or more existing fields and one or more domain definitions associated with the different domain.

5. The method of claim 2, wherein the one or more tool categories, and the combination of the one or more tools for the each unique field is selected based on a confidence score obtained by matching the expected value of the each unique field with the one or more extracted values of the each unique field obtained from the plurality of documents of the specific domain.

6. The method of claim 5, wherein the combination of the one or more tools includes a predefined order in which the one or more tools are applied; and wherein the selection of the combination of the one or more tools and the predefined order for the each unique field, are modified to get the confidence score above a predetermined threshold, and wherein the confidence score above the predetermined threshold is indicative of an accurate extraction.

7. The method of claim 1, wherein the one or more tool categories comprises one or more of a regionalization, layout detection, pattern detection, content extraction, data validation, and data transformation set of tools.

8. The method of claim 1, wherein the plurality of field characteristics for the each unique field comprises a length, a location, a data type, a pattern, a layout, one or more business rules, and a content vicinity information of the each unique field.

9. A system for developing a pretrained model for extracting content from a corpus of documents, wherein the system comprises:
at least one processor;
a memory storing instructions that, when executed by the at least one processor, cause the system to:
receive the corpus of documents associated with a specific domain;
tag each unique field of a document with an expected value;
define a plurality of field characteristics for the each unique field of the document;
select for the each unique field one or more tool categories, and a combination of tools for each tool category, based on the plurality of field characteristics, wherein the one or more tool categories and the combination of tools for the each tool category are defined in a tool selection framework;
extract one or more values associated with the each unique field in the each document by using the one or more tool categories, and the combination of tools in the each tool category, wherein each value is associated with a confidence score obtained by matching the one or more extracted values associated with the each unique field with the expected value of the each unique field; and
update the one or more tool categories and the combination of tools for the each unique field based on the confidence score, wherein the updated one or more tool categories and the combination of tools of the tool selection framework comprise the pretrained models.

10. The system of claim 9, wherein the system is further configured to:
update the one or more tool categories, the combination of tools for the each tool category, and a predefined order of applying the combination of tools, for the each unique field element.

11. The system of claim 10, wherein the system is further configured to:
derive a set of tool categories, and a combination of tools for a new field based on tool categories and a combination of tools selected for existing fields and commonalities of field characteristics between the new field and the existing fields, wherein the new field and the existing fields belong to one or more documents of the corpus of document of the specific domain.

12. The system of claim 10, wherein the system is further configured to:
derive one or more tool categories and combination of tools for each tool category for a new field identified in a document pertaining to different domain, based on tool categories and combination of tools for the each tool category associated with one or more existing fields of the specific domain, commonalities of field characteristics between the new field and the one or more existing fields and one or more domain definitions associated with the different domain.

13. The system of claim 10, wherein the one or more tool categories, and the combination of the one or more tools for the each unique field is selected based on a confidence score obtained by matching the expected value of the each unique field with the one or more extracted values of the each unique field obtained from the plurality of documents of the specific domain.

14. The system of claim 13, wherein the combination of the one or more tools includes a predefined order in which the one or more tools are applied; and wherein the selection of the combination of the one or more tools and the predefined order for the each unique field, are modified to get the confidence score above a predetermined threshold, and wherein the confidence score above the predetermined threshold is indicative of an accurate extraction.

15. The system of claim 11, wherein the tool category is one of a regionalization, layout detection, pattern detection, content extraction, data validation, and data transformation set of tools.

16. The system of claim 9, wherein the plurality of field characteristics for the each unique field comprises a length, a location, a data type, a pattern, a layout, one or more business rules, and a content vicinity information of the each unique field.

17. A non-transitory computer-readable medium having stored thereon computer-readable instructions that, when executed by a processor, cause the processor to execute a pretrained model configured to:
receive the plurality of documents associated with one or more domains;
tag each unique field of a document with an expected value;
define a plurality of field characteristics for the each unique field of the document;
select for the each unique field one or more tool categories, and a combination of tools for each tool category, based on the plurality of field characteristics, wherein the one or more tool categories and the combination of tools for the each tool category are defined in a tool selection framework;
extract one or more values associated with the each unique field in the each document by using the one or more tool categories, and the combination of tools in the each tool category, wherein each value is associated with a confidence score obtained by matching the one or more extracted values associated with the each unique field with the expected value of the each unique field; and
update the one or more tool categories and the combination of tools for the each unique field based on the confidence score.

18. The non-transitory computer readable medium of claim 17, wherein the pretrained model is further configured to:
derive a set of tool categories, a combination of tools and a predefined order of applying the combination of tools for a new field in a document of the specific domain based on tool categories and a combination of tools selected for existing fields and commonalities of field characteristics between the new field and the existing fields, wherein the new field and the existing fields belong to one or more documents of the corpus of document of the specific domain; and
utilize the set of tool categories and the predefined order of applying the combination of tools to extract value associated with the new field in the document of the specific domain.

19. The non-transitory computer readable medium of claim 17, wherein the pretrained model is further configured to:
derive one or more tool categories, a combination of tools for each tool category and a predefined order of applying the combination of tools for a new field identified in a document pertaining to a different domain, based on tool categories, combination of tools for the each tool category and an order to applying the combination of tools associated with one or more existing fields of the specific domain, commonalities of field characteristics between the new field and the one or more existing fields and one or more domain definitions associated with the different domain; and
utilize the set of tool categories and the predefined order of applying the combination of tools to extract value associated with the new field in the document of the different domain.
